(19) United States
(12) Patent Application Publication
(10) Pub. No.: US 2005/0082283 A1
(43) Pub. Date: Apr. 21, 2005

(54) Microwave dryer

(76) Inventors: William Hein, Sheridan, WY (US); Brian Granger, Sheridan, WY (US)

Correspondence Address: Gene R. Woodle, 3516 Woodle Dr., Rapid City, SD, 57702, US

(21) Appl. No.: 10/688,584

(22) Filed: Oct. 17, 2003

(51) Int. Cl. H05B 6/78

(52) U.S. Cl. 219/700

(57) ABSTRACT

Embodiments of a microwave dryer are disclosed which may be used to dry materials such a sewage sludge. The microwave dryer uses a reciprocating ram to push the material through a loading section and into a treatment section where the material is subjected to microwaves to drive of liquid content. The material is then pushed into an unloading section where it is removed from the microwave dryer.

### BACKGROUND OF THE INVENTION

1. Field of the Invention

The present invention relates generally to an apparatus for treating sludges and more specifically to a microwave dryer which provides for the continuous drying and sterilization of sewage sludge or similar materials.

2. Background Information

For hundreds of years people have been dealing with problems relating to the treatment and disposal of sewage. In modern times, most often, sewage is collected through a system of sewer lines and travels to a community treatment facility. Methods of treatment vary, but conventional treatment involves primary treatment to prepare waste for secondary biological treatment. Primary treatment usually involves screening to remove large solids and settling to remove grit. Often pH is adjusted and oils and greases are removed by flotation or filtration. Biological treatment involves the biological degradation of soluble organic compounds.

Eventually, the waste is separated into a liquid component which may be treated with chlorine or other chemicals and a solid component usually described as sludge. On a volume basis, treatment of sludge is very expensive and the instant invention relates to the treatment of such sludge. Although it may have a water content of up to 85% by weight, sludge is treated as a solid. As a part of the sludge treatment process, as much of the water is removed as may be done efficiently using methods such as vacuum or centrifugal filters.

Several patents have been issued which disclose methods or apparatus for drying or for treating waste water or sludge or both. The patent to Azam et al. (U.S. Pat. No. 4,184,956; Jan. 22, 1980) discloses a duct through which the material to be treated passes and a method for “irradiating” the material from opposite directions. The patent to Gaon et al. (U.S. Pat. No. 5,202,139; Apr. 13, 1993) discloses a process for preparing fat free snack chips. This patent describes a microwave transparent conveyor belt which transports the chips through both high and low intensity microwaves.

The microwave dryer of the instant invention is believed to solve, in a new and unique fashion, the above described problems relating to dewatering sludge by micro waving the sludge in a continuous process and removing the water from the apparatus.

One of the major objects of the present invention is to provide a microwave dryer which may be used to remove water from sludge in a continuous process.

Another objective of the present invention is to provide a microwave dryer which help to sterilize the sludge and destroys dangerous microorganisms.

Another objective of the present invention is to provide a microwave dryer which may easily be adapted to treating various quantities and types of sludge.

Another objective of the present invention is to provide a microwave dryer which is simple, safe, rugged, inexpensive, and easy to use.

These and other features of the invention will become apparent when taken in consideration with the following detailed description and the drawings.

### SUMMARY OF THE INVENTION

The microwave dryer of the instant invention comprises a loading section, a treatment section, and an unloading section. The sections are designed to be modular such that several treatment sections may be connected in line to treat a greater amount of sludge. In addition, sections may be stacked such that, for example, three treatment sections could be stacked vertically with complementary loading and unloading sections to treat roughly three times as much sludge as in a single treatment section in the same amount of space.

A first loading section is provided which includes a hopper on the top of the section into which untreated sludge may be introduced by a conveyor or other conventional means. The sludge drops into a channel which has a half-cylinder bottom and vertical side walls. A hydraulically operated, reciprocating ram is provided which pushes the sludge from the loading section into a treatment channel within the treatment section. The treatment channel has the same cross-sectional shape as the channel. A plurality of microwave guides which are covered with a microwave transparent cover open into the interior of the treatment channel. Microwaves are emitted from the guides and heat the sludge as it passes through the treatment section. Air is introduced into the downstream end of the treatment section. The air passes over the sludge in the treatment section, picks up the water which is driven from the sludge by the microwaves, and is extracted from the treatment section near the upstream end of the treatment section. The water may then be removed from the air by a condenser or other conventional means.

The sludge is then forced by the reciprocating ram from the treatment section into the unloading section. If the microwave dryer is configured on a single level, the treated sludge is removed from the bottom, downstream end of the unloading section by a conventional auger. If the dryer is configured on multiple levels, the sludge drops down a chute into a second loading section where a second reciprocation ram pushes the sludge through a second treatment section in the opposite direction as it was pushed through the first treatment section.

The various loading section channels, treatment section channels, and unloading section channels are affixed to each other and all ride on hydraulic lifts such that the slope of the channels may be adjusted to change the flow rate of the sludge and separated liquids through the various sections. Sensors are placed at various points along the sludge stream to monitor the temperature and the amount of water in the channels.

Although the microwave dryer of the instant invention is described as being used for the treatment of sludge and this is the preferred embodiment of the invention, the microwave dryer could be easily adapted to dry a wide variety of materials such as corn, coal, or wood chips.

### BRIEF DESCRIPTION OF THE DRAWINGS

FIG. 1 is a side view of the microwave dryer of the instant invention configured in three levels;

FIG. 2 is a partial sectional view of the microwave dryer of the instant invention taken along line 2-2 of FIG. 1;

FIG. 3 is a partial sectional view of the microwave dryer of the instant invention taken along line 3-3 of FIG. 2;

FIG. 4 is an end view of the microwave dryer of the instant invention; and

FIG. 5 is a partial side view of the microwave dryer of the instant invention similar to the view shown in FIG. 3, but showing greater detail.

### DESCRIPTION OF A PREFERRED EMBODIMENT

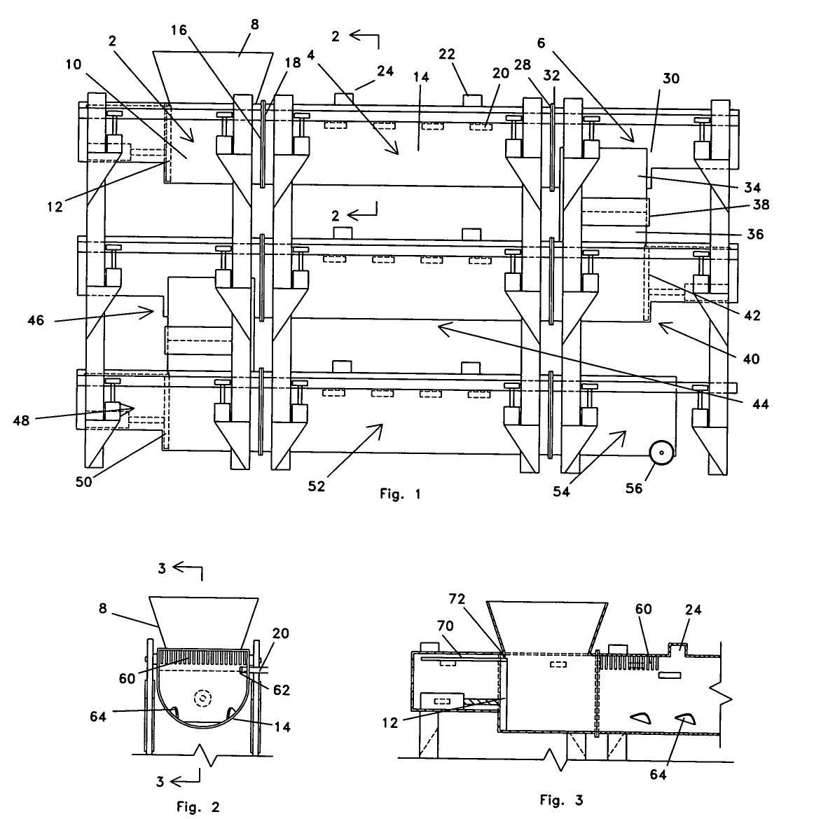

Referring to the drawings, FIGS. 1 through 5, a preferred embodiment of the microwave dryer of the microwave dryer of the instant invention is shown.

Referring now to FIG. 1, the microwave dryer of the instant invention may be divided into a loading section 2, a treatment section 4, and an unloading section 6. The loading section 2 is considered to be at the upstream end of the dryer and the unloading section 6 is considered to be at the downstream end of the dryer. Sludge may be introduced into said loading section 2 by a conveyor (not shown) or other conventional means through a hopper 8. The sludge falls through the hopper 8 into a loading channel 10. The loading channel 10 has a bottom in the shape of a half cylinder, two vertical side walls, and a top which is open beneath said hopper 8. A reciprocating ram 12 is provided which has the same shape and size as the interior of said loading channel 10 and fits within said loading channel 10. The reciprocation ram 12 is hydraulic and is capable of pushing the sludge from beneath said hopper 8 into the treatment section 4.

Still referring to FIG. 1, said treatment section 4 includes a treatment channel 14 which has the same cross-sectional shape as said loading channel 10. Said loading channel 10 includes a loading flange 16 and the loading flange 16 may be bolted to a complimentary treatment flange 18 on the treatment channel 14. A plurality of microwave guides 20 open into the interior of said treatment channel 14 and emit microwaves through the sludge. This heats the sludge and acts to drive off the water from the sludge. Dry air is introduced into the interior of said treatment channel 14 at the downstream end of said treatment channel 14 through an air intake 22. The air passes over the sludge and is removed from the upstream end of said treatment channel 14 through an air outlet 24. Air flow is powered by conventional fans (not shown) and water may be removed from the air by a condenser or other conventional means.

Still referring to FIG. 1, said reciprocating ram 12 further pushes the sludge through said treatment section 4 and into the unloading section 6. Said unloading section 6 includes an unloading channel 30 which also has the same cross-sectional size and shape as said loading channel 10. The unloading channel 30 includes an unloading flange 32 which may be bolted to a second treatment flange 28. The bottom of said unloading channel 30 opens into a chute 34 which is in communication with a loading chute 36 beneath the chute 34. A collar 38 surrounds the top of the loading chute 36 and is affixed to said loading chute 36. Said chute 34 fits within the collar 38 and may slip up and down within said collar 38. Sludge pushed by said reciprocating ram 12 drops through said chute 34 and said loading chute 36 and into a second loading section 40. A second reciprocating ram 42 may then push the sludge through a second treatment section 44 and into a second unloading section 46. The sludge then drops through another set of chutes and into a third loading section 48. A third reciprocating ram 50 then pushes the sludge through a third treatment section 52 and into a third unloading section 54. The treated sludge may then be removed from the dryer by means of a conventional auger 56 in the downstream, bottom end of the third unloading section 54. The second and third sets of sections are configured the same as the first sections and will not be described in detail.

Referring now to FIG. 2, a partial sectional view of the microwave dryer of the instant invention taken along line 2-2 of FIG. 1 is shown. A plurality of microwave reflecting rods are suspended from the top of the upstream end of said treatment channel 14 and act as a choke 60 to prevent potentially dangerous microwaves from escaping through said hopper 8. The choke 60 creates a high reflection coefficient to energy escaping through the apparatus using passive, loss-less reflectors. Said choke 60 is an array of posts forming a band-stop filter. Said choke 60 relies on the material flowing beneath said choke 60 to absorb microwave energy. Any waves which tend to flow in the air space between the top of the material and said choke 60 will encounter a high impedance zone and will be turned back into the apparatus. Said microwave guides 20 open into the interior of said treatment channel 14 and the ends of said microwave guides 20 are covered microwave transparent end caps 62 to prevent contaminants from entering said microwave guides 20. A plurality of stirring vanes 64 are affixed to the interior wall of said treatment channel 14 to stir the sludge as it is pushed through said treatment section 4.

Referring now to FIG. 3, a cross-sectional view of the microwave dryer of the instant invention taken along line 3-3 of FIG. 2 is shown. This view shows the position of said choke 60. This view also shows a cover 70 which is affixed to the top of said reciprocating ram 12 and protrudes upstream from said reciprocating ram 12. The cover 70 acts to close the opening beneath said hopper 8 when said reciprocating ram 12 is in the downstream position and prevents sludge from falling into said loading channel 10 upstream of said reciprocating ram 12. A scraper 72 is affixed to the top of said loading channel 10 and protrudes downward from a point beneath the upstream end of said hopper 8. The scraper 72 contacts the top of said cover 70 and scrapes sludge from the top of said cover 70 when said reciprocating ram 12 is moving in an upstream direction.

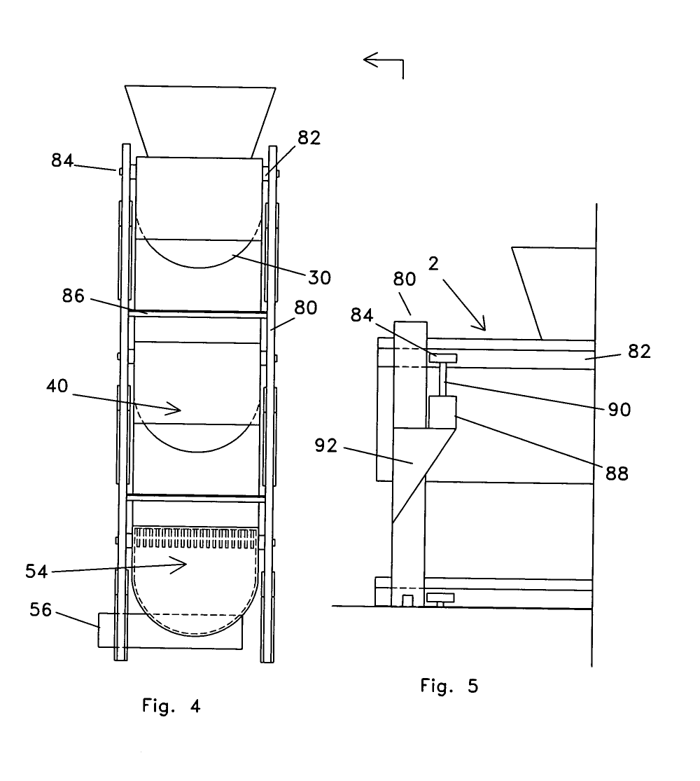

Referring now to FIG. 4, an end view of the microwave dryer of the instant invention is shown looking at the downstream end of said unloading channel 30. The dryer structure is supported by a plurality of columns 80. There is a pair of columns 80 at the upstream end and at the downstream end of each of the sections of the dryer. The bases of each of said columns 80 may be secured in any of a number of conventional ways including concrete footings and anchor bolts (not shown). A beam 82 is affixed to both sides of each of the channels of all of the various sections near the top outer surface of each of the sections. The beams 82 are positioned between the channels and said columns 80. A series of supports 84 having a horizontal bottom surface is affixed to said beams 82 such that they protrude outward beyond said columns 80. There is a pair of supports 84 at each end of each of the channels. For example, this view shows said supports 84 at the downstream end of said unloading channel 30, said second loading channel 40, and said third unloading channel 54. Column supports 86 are affixed to and secure each pair of said columns 80.

Referring now to FIG. 5, a side, detail view of the upper upstream end of the microwave dryer of the instant invention is shown. Said columns 80 are not affixed to either said beams 82 or said supports 84, but the outer surface of said beams 82 contact and ride on the inner surface of said columns 80 and the edges of said beams 82 may contact the edges of said supports 84. This allows the channels to move up and down, but prevents movement in other directions. Hydraulic supports 92 are affixed to said columns 80 at the location of each of said supports 84 and protrude beneath each of said supports 84. A hydraulic cylinder 88 is affixed to the top of each of the hydraulic supports 92 and a hydraulic rod 90 protrudes upward from each of the hydraulic cylinders 88 and contacts the bottom surface of each of said supports 84. Each of said hydraulic cylinders 88 are connected and controlled such that the slope of the connected channels may be adjusted by extending or retracting the hydraulic rods 90.

A plurality of conventional sensors (not shown) are located within each of the treatment sections and monitor the temperature, humidity, material flow rate, and material level. The water content of the sludge exiting said auger 56 is also monitored. The microwaves are generated and transmitted to said microwave guides 20 in a conventional manner which uses a conventional magnetron (not shown). The microwave generator, said hydraulic cylinders 88, the sensors, and the reciprocating rams are all connected to a microprocessor. The PLC controls the cyclic rate of the reciprocating rams, the height of said hydraulic rods 90, and the output of the microwave generator. If the temperature at any point within the treatment sections gets to high or too low, the microprocessor adjusts the level of microwaves in the appropriate microwave guide 20 to adjust the temperature. The speed of the movement of the sludge through the microwave dryer is adjusted by adjusting the cyclic rate of the reciprocating rams and the slope of the channels. The microprocessor also adjusts the rate of air flow through said air intakes 22. In the configuration described above, the air flow may be regulated from 0 to 7,000 cfm, the microwave generator from 0 to 1,250 kw, and the flow of sludge from 0 to 4 tons per hour.

The control system (not shown) is PLC based and will take inputs from a conventional automatic magnetron protection system, user safety securities, and process control systems to evaluate and control all microwave generation and material flow. The automatic magnetron protection system includes a cooling system for the magnetron, and electromagnetic current monitoring system, and filament current monitoring system, an anode current monitoring system, a reflected power monitoring system, and an arc detection circuit. The magnetron is a conventional device used to supply microwaves to said microwave guides 20.

The cooling system includes two flow switches and a thermostat. The first flow switch is located on the discharge side of the primary supply main. The second flow switch is located downstream of the magnetron in the secondary coolant system through the magnetron. The thermostat is located on the downstream side of the magnetron in the secondary coolant system. All of the switches for the cooling system ensure that the magnetron does not get overheated and decrease the life span of the magnetron tube. The monitoring circuit for the electromagnetic current is set to drop out when the current reaches 75% of the lowest optimum operating current. The monitoring circuit also monitors the integrity of the supply, with the most likely fault being total lack of current. The filament current is monitored in the secondary of the EHT insulated filament transformer. It is set to drop out at 75% of the lowest optimum operating current.

The anode current monitoring system is the most critical in ensuring magnetron longevity and monitors the current flow to the anode, and if it exceeds the absolute maximum, it is set to drop out the EHT anode supply. The energy dissipated in the magnetron under the over-current fault conditions is proportional to the reaction time of the interlock, which is the time taken for the main contactor in the power supply to clear its contactor. Reflected power is diverted and monitored. The power is diverted away from the magnetron into a dummy water load using a three port circulator. The reflected power is also measured, and if it rises above a preset limit, the magnetron is switched off.

An arc detection system is provided in the interior of the apparatus and monitors the interior and the wave guides for any arcing. If arcing is detected, the entire system goes into a standby mode for five seconds to allow any ionized gases to disperse before reapplying power to the system. In the event that arcing persists, the power which provides microwaves to said microwave guides 20 is cut and said reciprocating rams 12 continue operating which will break up the area in the material where voltage breakdown occurred. The arc detector is conventional, is optical, and uses a photodiode.

A user safety system is also provided which includes two electronic systems. A material system ensures that there is sufficient material within the apparatus to warrant operation. If there is insufficient material, power can not be applied to the magnetron. A microwave detection system includes microwave detectors located near any open apertures. If these detectors detect microwave leakage beyond acceptable levels, power to the magnetron is cut off.

The process control system takes input from the humidity, temperature, and flow rate sensors to control the frequency of said reciprocating rams 12, air movement over the material, and the power output from the microwave generators. A plurality of humidity sensors are located along the material stream, at said air intakes 22, and at said air outlets 24. If humidity above acceptable levels is detected, air flow through the apparatus is increased by increasing air flow through said air intakes 22 and said air outlets 24. A plurality of temperature sensors are also located along the material stream. If temperature levels are greater than optimum, power to the microwave generators is reduced and, if temperature levels are less than optimum, power to the microwave generators is increased. Flow rate and material level sensors are located at the upstream end of each of said treatment sections 4. If these sensors detect too little material within any of said treatment sections 4, the frequency of operation of said reciprocating rams 12 will be increased. If these sensors detect too much material within any of said treatment sections 4, the frequency of operation of said reciprocating rams 12 will be decreased.

Furthermore, said hydraulic cylinders 88 are also controlled by the control system. In the event that material is flowing too rapidly through the dryer, said hydraulic cylinders 88 may be activated to raise the downstream ends of said treatment sections 4. In the event that material is flowing to slowly through the dryer, said hydraulic cylinders 88 may be activated to lower the downstream ends of said treatment sections 4.

Depending upon treatment requirements and space available, the configuration of the microwave dryer may be changed in a variety of ways. As described above, the dryer includes three loading sections, three treatment sections, and three unloading sections on three levels. The dryer could also be configured with a single level with a single treatment section or with multiple treatment sections. If configured in this manner, said unloading section 6 would be replaced with said third unloading section 54. Similarly, the dryer could be configured in two or four levels or with multiple levels and more than a single treatment section in each level.

In the preferred embodiment of the microwave dryer of the instant invention, unless otherwise specified; all elements are made from steel, but other materials having similar strength, pliability, and weather resistance could be used. All materials or elements which come into contact with corrosive materials are coated to prevent corrosion. The various channels, said beam 82, said supports 84, and said hydraulic supports 92 are made from aluminum; but other materials having the same strength, weight characteristics, and corrosion resistance could be used. The interior of the various channels are lined on the inside surfaces to increase wear, resist degradation from high temperatures, and provide a low friction coefficient. Various materials including polyetherimides could be used.

A number of companies specializing in manufacturing microwave systems can manufacture the above described microwave system including all described controls and sensors. Such companies include Richarson Electronics, Woodland Hills, Calif.; Ferrite, Hudson, N.H.; and California Tube Laboratory, Inc.; Watsonville, Calif.

Although the microwave drier of the instant invention has been described as being used for treating sludge, that was just one example of possible uses and the microwave drier could be used for drying any number of materials including coal, corn, or wood chips.

While preferred embodiments of this invention have been shown and described above, it will be apparent to those skilled in the art that various modifications may be made in these embodiments without departing from the spirit of the present invention.

1. A microwave dryer for drying various materials including:
(1) a loading section into which the material may be introduced using loading means;
(2) a treatment section which is in communication with the loading section;
(3) an unloading section which is in communication with the treatment section;
(4) a reciprocating ram within said loading section which is capable of pushing the material from said loading section into said treatment section and through said treatment section into said unloading section;
(5) a plurality of microwave guides within said treatment section capable of directing microwaves from a microwave generator into the material within said treatment section; and
(6) unloading means capable of removing the material from said unloading section; whereby material may be loaded into said loading section and pushed into said treatment section by the reciprocating ram; the material treated by microwaves within said treatment section; the treated material further pushed by said reciprocating ram into said unloading section; and the material removed from said unloading section by unloading means.

2. The microwave dryer of claim 1 in which outside air is introduced into the microwave dryer, passes over the material, and is removed from the microwave dryer.

3. The microwave dryer of claim 1 in which said treatment section may be tilted at an angle other than level to increase or decrease the flow rate of material through said treatment section.

4. The microwave dryer of claim 1 in which said loading section, said treatment section, and said unloading section are modular such that the length of the microwave dryer may be adjusted or the various sections stacked vertically to increase the effective length of the microwave dryer.

5. The microwave dryer of claim 2 in which said treatment section may be tilted at an angle other than level to increase or decrease the flow rate of material through said treatment section.

6. The microwave dryer of claim 4 in which said treatment section may be tilted at an angle other than level to increase or decrease the flow rate of material through said treatment section.

7. The microwave dryer of claim 3 in which outside air is introduced into the microwave dryer, asses over the material, and is removed from the microwave dryer.

8. The microwave dryer of claim 4 in which outside air is introduced into the microwave dryer, passes over the material, and is removed from the microwave dryer.

9. The microwave dryer of claim 2 in which said treatment section may be tilted at an angle other than level to increase or decrease the flow rate of material through said treatment section; and said loading section, said treatment section, and said unloading section are modular such that the length of the microwave dryer may be adjusted or the various sections stacked vertically to increase the effective length of the microwave dryer.

10. The microwave dryer of claim 3 in which outside air is introduced into the microwave dryer, passes over the material, and is removed from the microwave dryer; and said unloading section are modular such that the length of the microwave dryer may be adjusted or the various sections stacked vertically to increase the effective length of the microwave dryer.

11. The microwave dryer of claim 4 in which outside air is introduced into the microwave dryer, passes over the material, and is removed from the microwave dryer; and in which said treatment section may be tilted at an angle other than level to increase or decrease the flow rate of material through said treatment section.
